(19) United States
(12) Patent Application Publication
(10) Pub. No.: US 2017/0006911 A1
(43) Pub. Date: Jan. 12, 2017

(54) DUMPLING MAKER AND METHOD OF USE

(71) Applicant: Primraj Lutchmansingh, Smiths Falls (CA)

(72) Inventor: Primraj Lutchmansingh, Smiths Falls (CA)

(21) Appl. No.: 14/667,600

(22) Filed: Mar. 24, 2015

(30) Foreign Application Priority Data
Mar. 27, 2014 (CA) 2847638

(51) Int. Cl. A23P 20/20; A21C 9/08; A21C 9/06

(52) U.S. Cl. CPC A23P 20/20; A21C 9/065; A21C 9/088; A21C 9/063

(57) ABSTRACT

A wonton maker has a fill chamber, a fill injector unit having a valve for controlling the flow of the fill and a fill injector nozzle in communication with the valve for injecting fill within a wonton wrapper, and a wonton folder unit having a loading plate for loading wonton wrappers, a split plate each side of which forming a clamp with a wing clamp mounted above it, and a moistener for moistening the folded edge of the wonton wrapper, wherein the fill injector unit receives fill from the fill chamber, the nozzle pushes the wonton wrapper through the loading plate to fold the wrapper over the nozzle, the nozzle injects fill into the wonton wrapper, and wherein the wonton wrapper is folded by the two clamped sides of the wonton moving together once the folded edge of the wonton wrapper is moistened.

### FIELD

The present invention is in the field of food preparation equipment, and more specifically, dumpling (wonton) makers.

### BACKGROUND

Dumplings, in particular Wontons have been made by hand for millennia. They generally consist of a small square of dough, into which a filling is placed. The dough is folded around the filling and held together by adhesion of the dough as it is moistened. Wontons can be folded a number of different ways but each way functions to hold the filling within the wonton while the wonton is cooked.

The process of folding wontons by hand has made the mass production of wontons expensive and inefficient in developed countries with high labor costs. Large, complex commercial machines for the production of wontons have been developed, but are not in widespread usage and lack the small footprint and affordability for a restaurant or small manufacturer.

Therefore there is a need for a machine to replace the hand labor of the traditional wonton manufacturing process, while producing usable wontons rapidly. It is preferable if the machine can be made affordable with a small size and low energy consumption for the small-scale commercial market.

### SUMMARY

A dumpling (wonton) maker has a fill chamber capable of being pressurized, a fill injector unit in communication with the fill chamber, the fill injector comprising a valve for controlling the flow of the fill, a fill injector nozzle in communication with the valve for injecting fill within a wonton wrapper, and a wonton folder unit comprising a loading plate for loading wonton wrappers, a split plate comprising first and second sides, each side rotatable independently, wherein the plate is for holding a folded wonton wrapper having first and second sides, a first side wing clamp above the first side of the split plate, wherein the first side wing clamp and first side of the split plate move together to clamp the first side of the wonton wrapper, a second side wing clamp above the second side of the split plate, wherein the second side wing clamp and second side of the split plate move together to clamp the second side of the wonton wrapper; and a moistener for moistening the folded edge of the wonton wrapper wherein the fill injector unit receives fill from the fill chamber, the nozzle pushes the wonton wrapper through the loading plate to fold the wrapper over the nozzle, the nozzle injects fill into the wonton wrapper, and wherein the wonton wrapper is folded by the first side wing clamp and first side of the split plate meeting the second side wing clamp and the second side of the split plate and joining the first and second sides of the wonton wrapper to adhere to each other, once the folded edge of the wonton wrapper is moistened.

A further embodiment has a pressurization means for pressurizing the fill chamber, and/or a removable fill tube for transmitting fill in communication with the fill chamber and the fill injector unit. In an embodiment one or more alignment tabs are adjacent to the nozzle for folding the wonton wrapper. The wonton maker may have side clamps to hold the sides of the wrapper against the plate to contain the injected fill. The first side wing clamp and first side of the split plate may rotate towards the second side wing clamp and the second side of the split plate to fold the wonton.

In an embodiment, the wonton maker has a hopper for loading a plurality of wonton wrappers, wherein wonton wrappers are positioned one at a time on the loading plate. The valve opening duration may be adjusted depending on the consistency of the fill, and the valve may be an air pinch valve. The fill injection unit may be removable for cleaning, and the wonton folder unit may be removable for cleaning. The wonton maker may have a packaging area for receiving the folded wonton.

In an embodiment, the wonton maker has a positive displacement pump in place of the valve, which pump moves the fill along from the fill container to the nozzle for application within a wrapper. In this case the fill chamber is not pressurized.

A method of making a wonton has the steps of pressurizing a fill chamber in communication with a fill injection nozzle, controlling a flow of fill through a fill injection nozzle, folding a wonton wrapper over the fill injection nozzle, the fill injection nozzle injecting fill into the wonton wrapper, clamping the sides of the wonton wrapper using clamps, moistening the folded edge of the wonton wrapper; and folding the wonton by bringing the sides of the wonton wrapper together.

In an embodiment the wonton is folded when the clamps rotate towards each other. The method may have the further step of holding the sides of the wonton while the fill is injected to contain the fill. It also may have the further step of receiving the folded wonton in a packaging area. In an embodiment the wonton wrapper is folded by pushing the wonton wrapper through a loading plate, and the wonton wrapper may be folded from corner to opposite corner.

### DESCRIPTION OF FIGURES

FIG. 1 is a perspective view of the wonton maker;

FIG. 2 is a detail view of the fill dispenser unit;

FIG. 3 is a detail view of the fill injector unit;

FIG. 4a is a detail view of the fill injector nozzle and wrapper plate;

FIG. 4b is a detail view of the fill injector nozzle pushing through the wrapper plate;

FIG. 5 is a detail view of the wonton folder unit; and

FIG. 6 shows a flowchart showing the steps of the method of folding a wonton.

### DETAILED DESCRIPTION

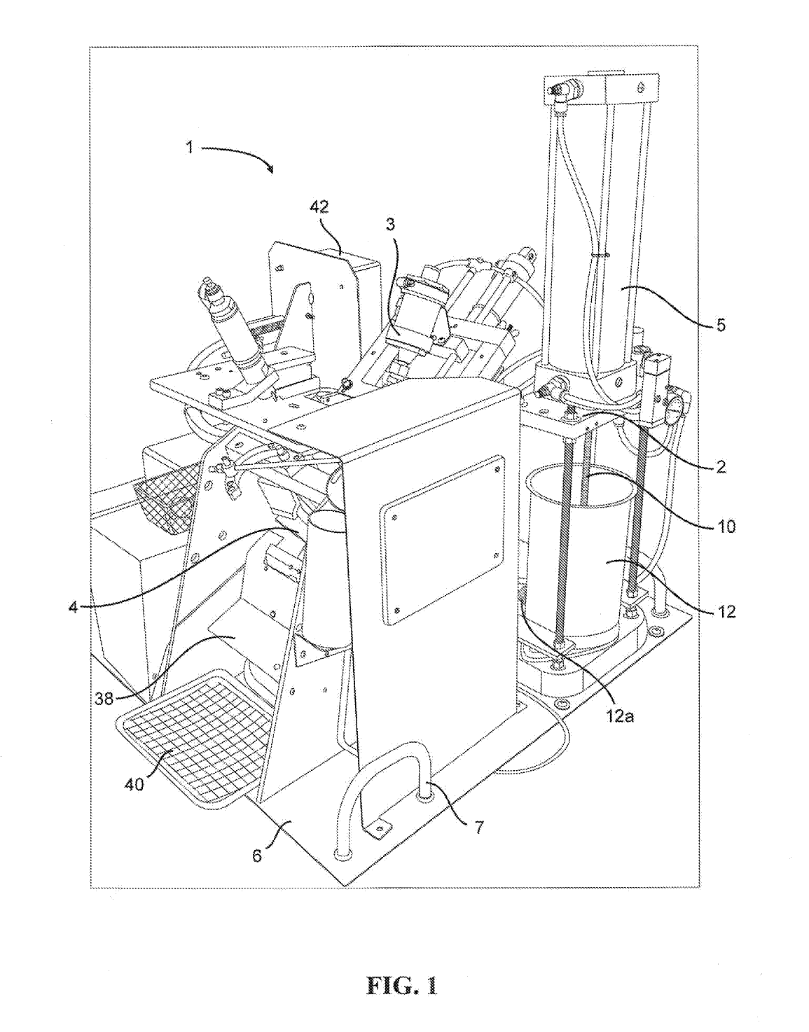

The device described is for folding dumplings such as, but not limited to, wontons. Having regard to FIG. 1, the wonton maker 1 generally comprises a pressurized fill dispenser unit 2 that contains and pressurizes the fill that is communicated to the fill injector unit 3, which injects the fill into a wonton wrapper. Finally, the wonton folder unit 4 folds the wonton and the completed wonton is sent down a guide 38 to the packaging area 40. The wonton maker may be mounted to a base 6 and have handles 7 for carrying it.

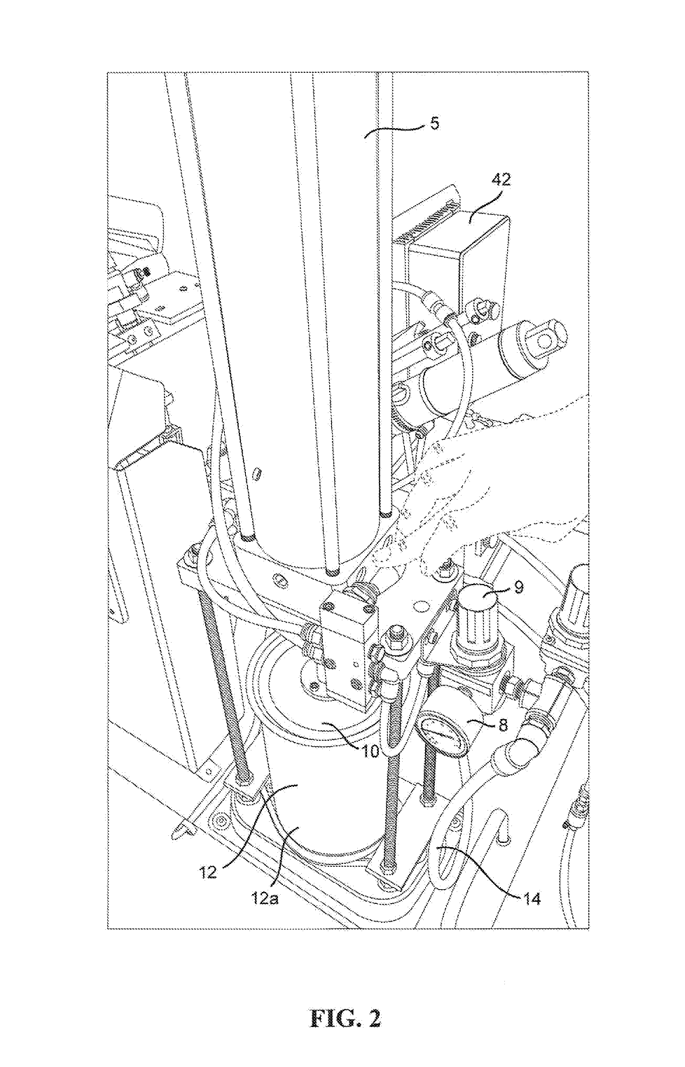

With respect to FIG. 2, the pressurized fill dispenser unit 2 consists of a pressurization means 5, which pressurizes a piston 10 disposed within a fill chamber 12. The piston 10 seals against the sides of the fill chamber 12 walls with a rubber or plastic gasket (not shown), for example, to maintain the fill under pressure. There are other ways of pressurizing the fill beside the use of a piston that are substitutable and do not deviate from the scope of the invention. A fill tube 13 connects the lower portion of the fill chamber 12a with the fill injector unit 3. The pressurized fill moves by the application of pressure from the lower portion of the fill chamber 12 down the fill tube 13 to the fill injector unit 3.

The pressurization means 5 for the piston 10 applies a downward force on the piston 10 when engaged. It may consist, for example, of compressed air, hydraulics or an electric motor. If compressed air or hydraulics, the pressure may come from a separate pressure source 14. In an embodiment, the pressurization is performed by hand. The pressurization means 5 may have controls 9 to select the level of pressurization for different fill consistency, and gauges 8 to monitor the functioning of the pressurization means 5. In one embodiment the control 9 output is determined by a microcontroller which determined the applied pressure. The pressurization means 5 may be disengaged to remove the piston when the fill chamber is empty, so as to refill the chamber or to replace the fill with a different flavor.

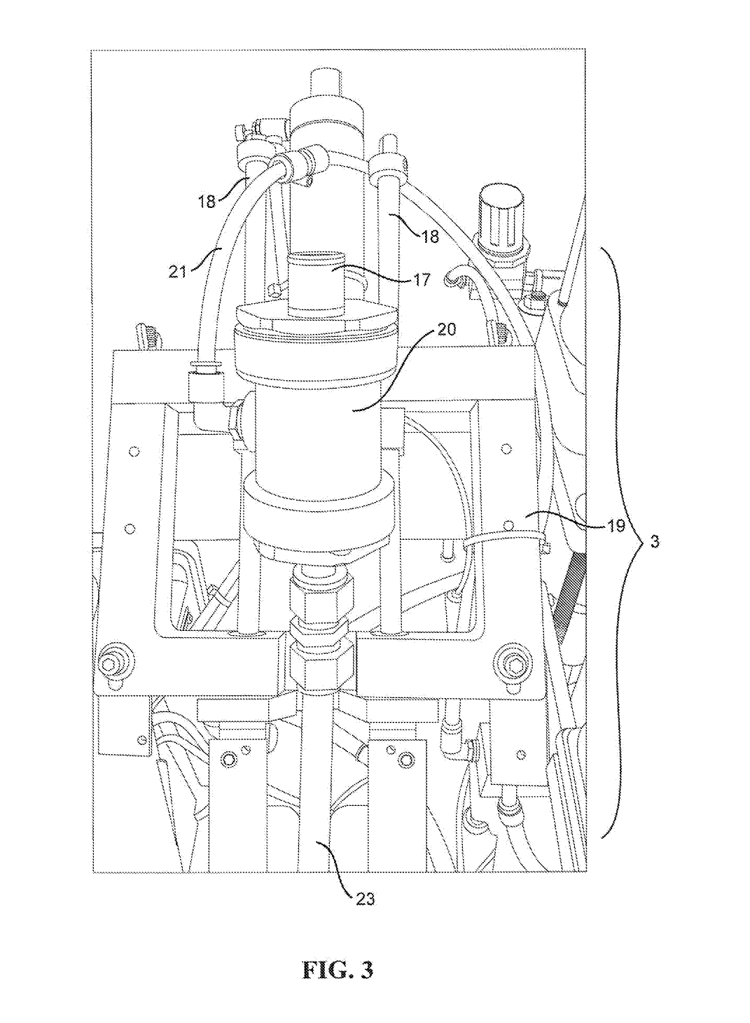

With regard to the fill injector unit 3, shown in FIG. 3, the fill tube connects with the valve intake 17. The valve intake 17 is at the inlet of a fill valve 20, and a dispenser tube 23 is at the outlet of the valve 20. In one embodiment the valve 20 is disposed vertically but this is not necessary and that valve may be in any orientation as it is pressure operated. The valve opens and closes to permit the pressurized fill to pass through the valve and into the dispenser tube. The opening time of the valve is adjustable in one embodiment, to account for different fill consistency and wonton sizes. The valve 20 is controlled by a control line 21, which control may be by air pressure, hydraulics or electric control. In one embodiment, the control line output, and hence the time the valve stays open, is determined by a microcontroller 42. The dispenser tube 23 terminates in a fill injector nozzle 25, which is flattened to produce an oval opening, so as to inject the fill within the wonton and minimize the surface tension force of the fill clinging to itself (product breakaway point). The nozzle 25 shape may vary, and may range from round or square to a flattened pyramid, oval or rectangle. Flattened orientations are preferable as they distort the wrapper least and also reduce the adhesion of the dispensed fill to the fill remaining in the dispenser tube 23. The fill injector unit 3 may be removed from the wonton maker 2 for cleaning and servicing.

In an embodiment, the fill chamber 12 is not pressurized and the valve 20 is replaced by a positive displacement pump, which moves the fill from the fill chamber 12 to the nozzle 25.

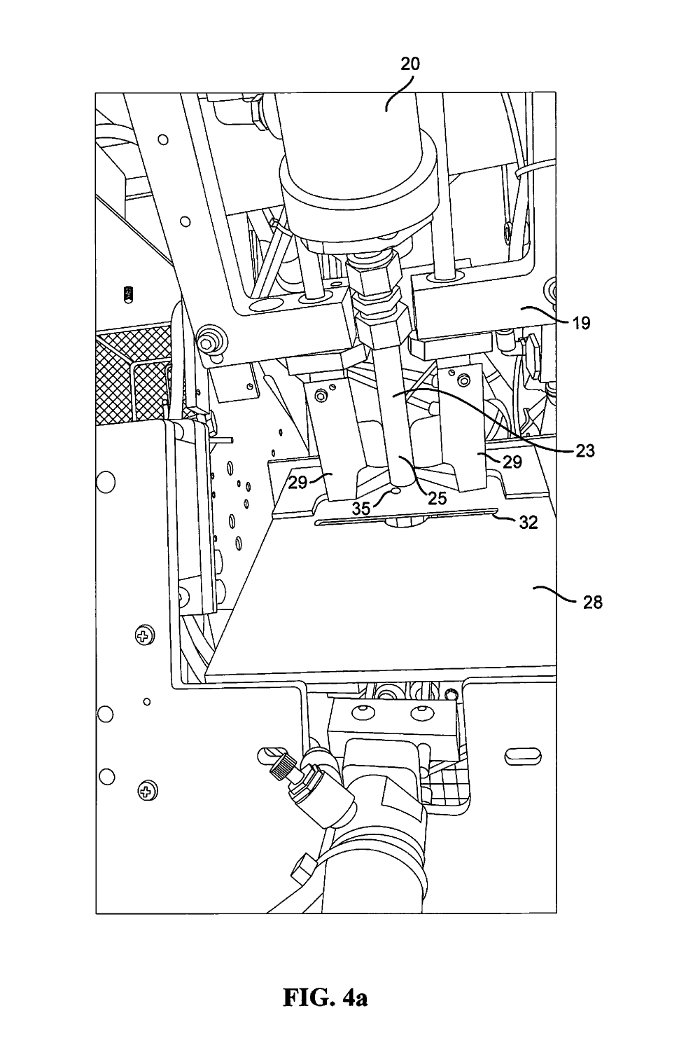

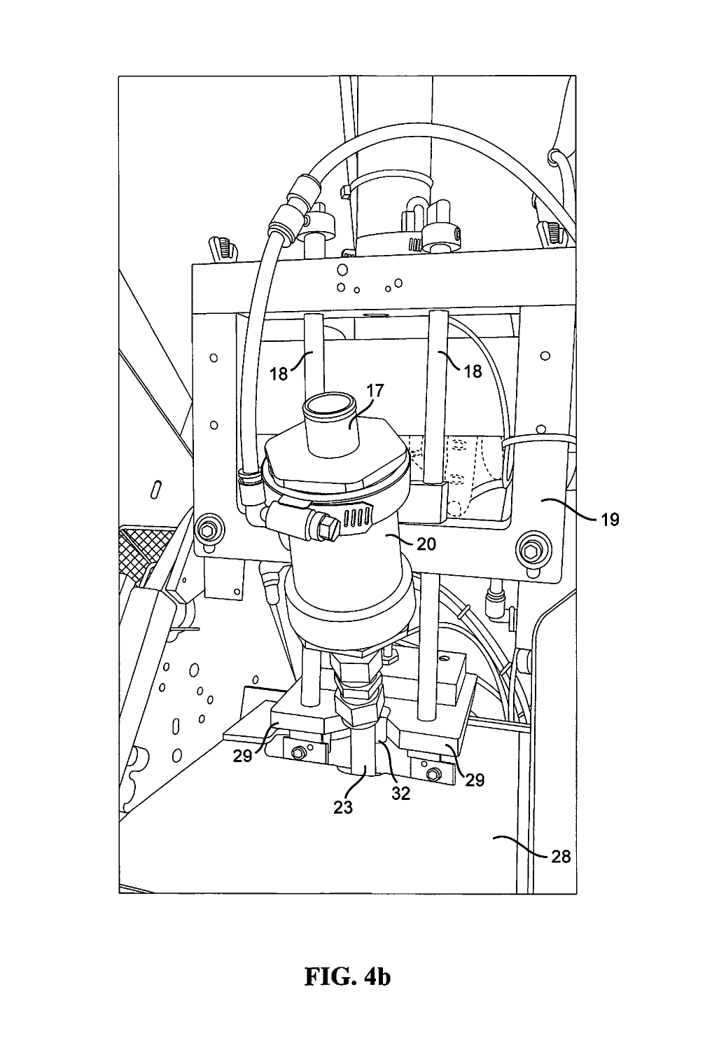

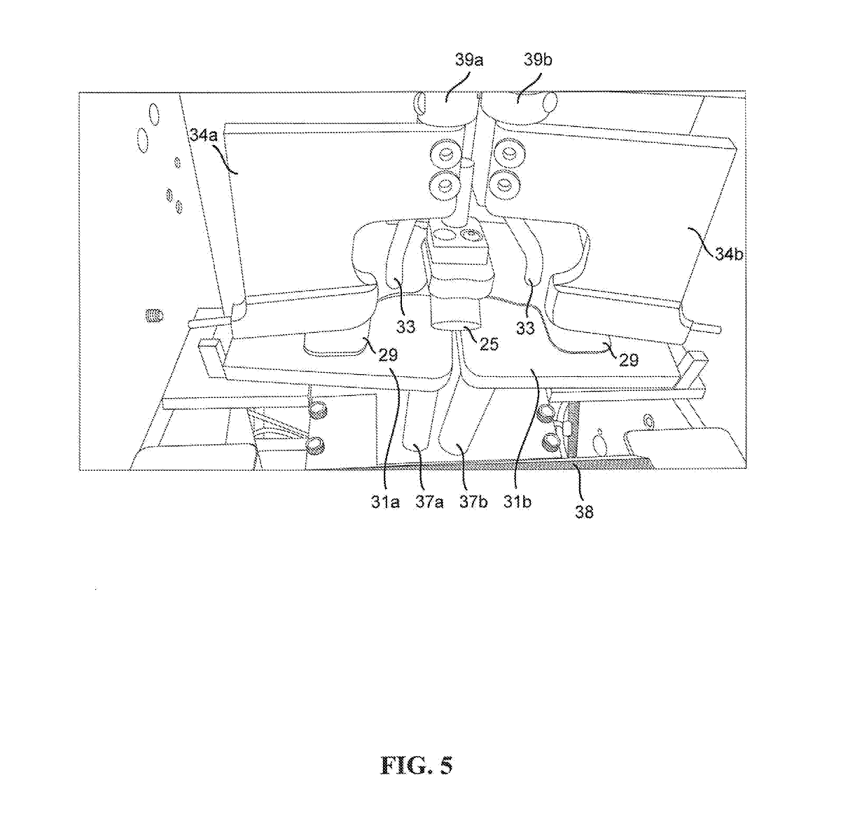

With reference to FIG. 4, the fill injector unit 3 is mounted on rails 18 that permit it to move in and out along the rails 18. It may have a frame 19 around the unit 3 to maintain The position of the fill injector unit 3 along the rails 18 is controlled by the microcontroller and pressure means, or an electric motor. Movement along the rails permits the fill injector nozzle 25 to pass through, and push a wonton wrapper through, a slot 32 in the loading plate 28.

With further reference to FIG. 4, the loading plate 28 of the wonton folder unit is shown. A single wonton wrapper is loaded into the loading plate 28 from above. A photo eye detects the presence of a wrapper on the loading plate 28. The loading plate 28 is inclined such that the wrapper rests on it. The loading plate 28 holds the wonton wrapper in a diamond orientation, such that the wrapper stands on one corner and has a vertical point. The loading plate 28 has a wrapper slot 32 pass-through across its middle, from corner to corner of the wrapper's position. Optionally, the fill injector nozzle 25 has alignment tabs 29 on either side of it that are flat for engaging the center of a wonton wrapper and keeping it in alignment while pushing it through a narrow wrapper slot 32 in the center of the loading plate 28.

In another embodiment, the wrapper is loaded on the loading plate 28 with a flat side down, such that when it is pushed through the slot 32 it folds over the nozzle 25 from side to side, rather than from corner to corner. This results in a slightly different fold and appearance, and the amount of insertable fill may also vary.

The fill injector nozzle 25 and alignment tabs 29 push the wonton by its center through the folder slot such that the wonton wrapper folds from corner to opposite corner and passes through the slot 32 in a folded state, to be positioned on a split plate 31. The split plate 31 is inclined to form a right angle where it intersects with the back of the loading plate 28, such that when the wrapper (not shown) is pushed through the slot 32 it is pushed onto the split plate 31. The split plate 31 is made up of two plates 31a, 31b pushed together to form a single surface and join on a center axis. The fold of the wonton wrapper is from corner to corner, such that it folds into an isosceles triangle. The wonton is folded over the alignment tabs 29 and the nozzle 25 for the nozzle to inject fill into the wonton wrapper. A side clamp 33 is lowered onto each side of the wonton, outside of the area of the wonton to be occupied by fill, in order to clamp the sides of the wonton wrapper to the split fold plate 31 while fill is injected into the wonton wrapper. The side clamps 33 hold the wonton against the split fold plate 31 while the nozzle 25 is removed, so the filling is not pulled out and the wonton is not misaligned by the removal of the nozzle 25.

Once the wonton is folded and contains filling, the nozzle 25 and alignment tabs 29 retract from the wrapper and subsequently the side clamps 33 are raised from the wrapper. The split fold plate 31, previously slightly inclined, is lifted by fold plate actuators 37a, 37b to a horizontal position so as to compress the wonton sides against two wing clamps 34 positioned above the plate 31, one wing clamp contacting each side of the wonton. Each wing clamp 34a, 34b corresponds to a side of the split fold plate 31a, 31b, and each split plate side has an actuator 37a, 37b to lift it. The wing clamps 34 are smooth on the bottom so as to prevent cutting of the wrapper.

Once the wing clamps 34 are holding the sides of the wonton against the split plate 31, the moistener 36 rises to contact the long folded edge of the wonton and moisten it. Once the wonton is moistened, it can adhere to itself, and the moistener 36 moves away again. A proxy switch (not shown) detects the position of the moistener 36. In a preferred embodiment the moistener 36 consists of a metal water trough that is kept moistened by a water supply. In other embodiments the moistener may consist of a sponge or other absorbent material, or a sprayer or water applicator, for transferring a small amount of water to the edge of the wonton. The water supply may contain additives like egg albumen or other substances to increase adherence of the wrapper edge.

When the split plate 31 rises, the wing clamps 34 are in a starting position, oriented opposite one another across the split plate 31. The wing clamp 34a holds the side of the wonton against split plate 31a, while wing clamp 34b holds the side of the wonton against split plate 31b. The sides of the split plate 31a, 31b split from each other and rotate approximately 90 degrees each toward each other to meet on the center axis, in a folding position. The wing clamps each have an actuator 39a, 39b to rotate the respective wing claim 34a, 34b. The wing clamps follow the split plate to maintain the wonton in a clamped state, and each rotates 90° in to meet the other in the center, ending in a folding position. Each wing clamp 31 and split plate 34 combination moves together to meet in the center, so that the wonton sides are brought together and the moistened folded edges meet and adhere. As the wonton sides are folded to meet each other, the front of the wonton folds up against itself, holding the fill therein. Once the wonton is formed, the split plate 31 drops away and the wonton falls away from the wing clamps. The formed wonton falls to a guide 38 that guides it to a packaging area 40. The entire folding unit 4 may be removed from the wonton maker 2 for maintenance and cleaning.

In one embodiment, a hopper (not shown) holds multiple wonton wrappers at once and provides the one pre-cut wrapper at a time to the loading plate 28. A magazine (not shown) is loaded with pre-cut wrappers, and vacuum suction is used to pull to top wrapper from the magazine and load it into the loading plate 28. In another embodiment, compressed air is used to separate a top wrapper from the magazine. Alternatively, the wrapper is uncut and on a roll, which unrolls and cuts a single wrapper at a time, which is positioned on the loading plate 28.

In a preferred embodiment, the wonton maker is controlled by a microcontroller or computer 42. The pressure of the pressurized fill dispenser unit 2 is determined and maintained constant by microcontroller controlling an air pump or hydraulics pump. The microcontroller determined the time the valve 20 of the fill injector unit 3 is held open to inject the fill into a wonton wrapper, and determines the movement of the nozzle 25 and alignment tabs 29 pushing the wrapper through the slot. If using a positive displacement pump instead of a valve 20, the microcontroller determines the speed of the pump. With regards to the wonton folder unit 4, the time the side clamp 33 is applied, the rate at which the wing clamps 34 and split plates 31 rotate are determined by the microcontroller, and may be adjusted to accommodate different types of wonton wrappers and fills. Further, the microcontroller determines the time that the split plate 31 is raised and the time of the moistener 36 is applied. To determine the position of the moistener 36, the microcontroller receives information from a proxy switch under the moistener 36. There is a sensor 35 that determines whether a wrapper is loaded into the loading plate 28, which provides information to the microcontroller.

In use, the fill chamber is filled with fill and closed by the piston. When the piston 10 is pressurized by the pressurization means, it exerts force downward into the chamber 12 to pressurize the fill. As the fill tube 13 is connected to the lower portion of the chamber 12, the pressurized fill is forced through the fill tube 13 to the valve intake 17 of the fill injector unit 3. The valve 20 opens by hydraulic or electric control for a specified time, the length of time depending on the fill consistency and the amount of fill desired. When the valve 20 opens, the fill is pushed through into the dispensing tube 23. The dispensing tube 23 is always full of fill, and each time the valve 20 opens and further fill is pushed into the dispensing tube 23, fill is displaced from the nozzle

The wonton wrapper is positioned on the loading plate 28 and the nozzle 25 of the dispensing tube 23 pushes the center of the wonton wrapper, which is pushed through a horizontal slot 32 in the loading plate 28 so as to fold the wrapper from corner to opposite corner, with the nozzle 25 positioned therein. The wrapper is pushed through the slot 32 by the nozzle 25, which descends as a part of the rail-mounted injection unit 3, and the wonton is positioned on the inclined split plate 31. The side clamps 33 descend to hold the wrapper against the split plate 31, while the valve 20 opens to inject fill into the wrapper.

The nozzle then retracts as the injection unit 3 slides up again on the rails. The side clamps 33 also move away as the split plate 31 rises up to clamp the sides of the wonton wrapper between the split plate 31 and the wing clamps 34. The moistener 36 rises to moisten the folded edge of the wonton and descends again. The split plate 31 splits and the two sides 31a, 31b each rotate 90° forward to meet in a folding position, and join the moistened edge of the wonton so it adheres to itself and remains in folded shape. The wing clamps 34a, 34b also rotate 90° to meet each other with the split plate sides 31a, 31b to keep the wonton side clamped. Once the wonton is adhered in a folded form, the split plate 31 drops away, releasing the finished wonton that drops to the packaging area 40. The wing clamps 34 rotate back into the starting position in preparation for the next wonton.

As the wonton maker is food preparation equipment, it is made from easy to clean materials that do not rust. The components that are in contact with the food are easy to clean and removable for a dishwasher where appropriate. In one embodiment, the fill chamber 12 is made of stainless steel while the piston 10 is made from food-safe plastic. The fill pipe is food-grade plastic and is removable for cleaning. In an embodiment the valve 20 is an air pinch valve and the fill injection unit 3 may be cleaned by running cleaning solution through the system or by removal and cleaning. The split plate 31 and wing clamps 34 are stainless steel or food-grade plastics, antibacterial or otherwise, for easy cleaning and to prevent mold or bacteria. To assist in cleaning, in an embodiment the entire fill injector unit 3 and folder unit 4 are removable from the wonton maker 2.

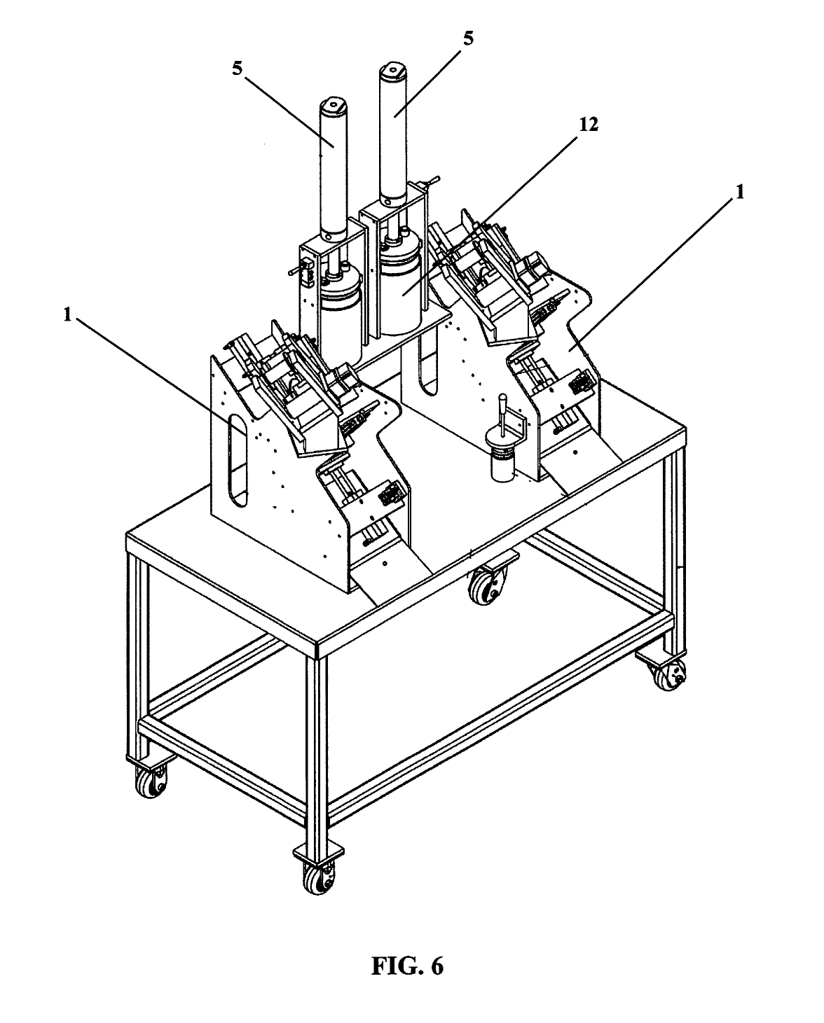

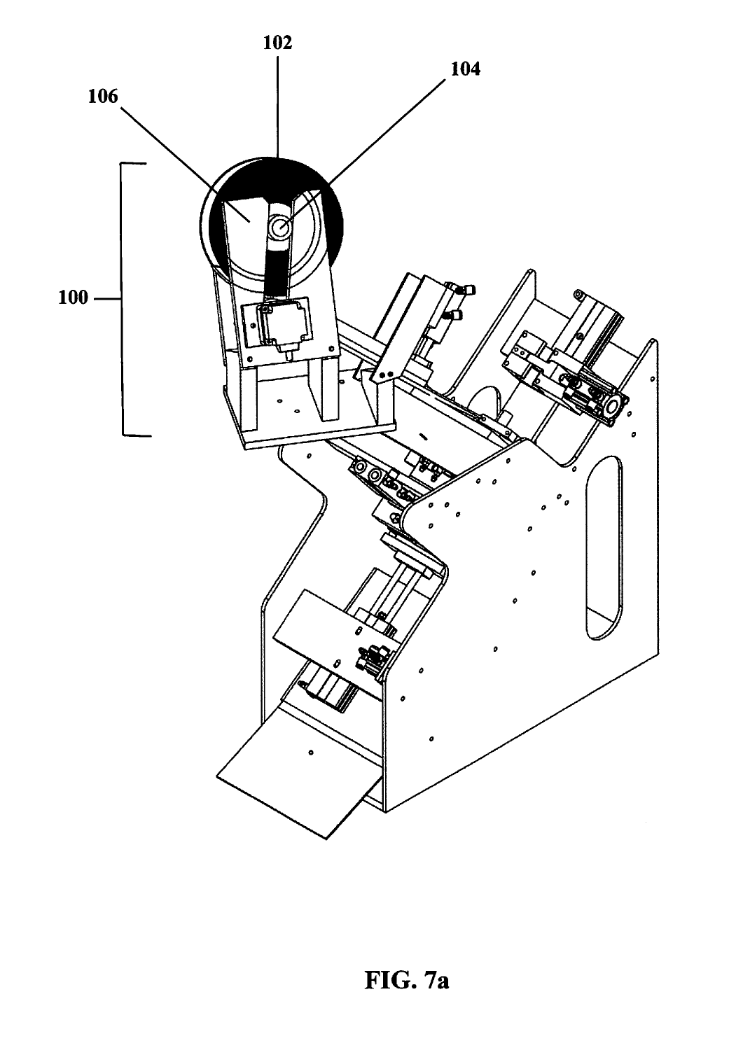

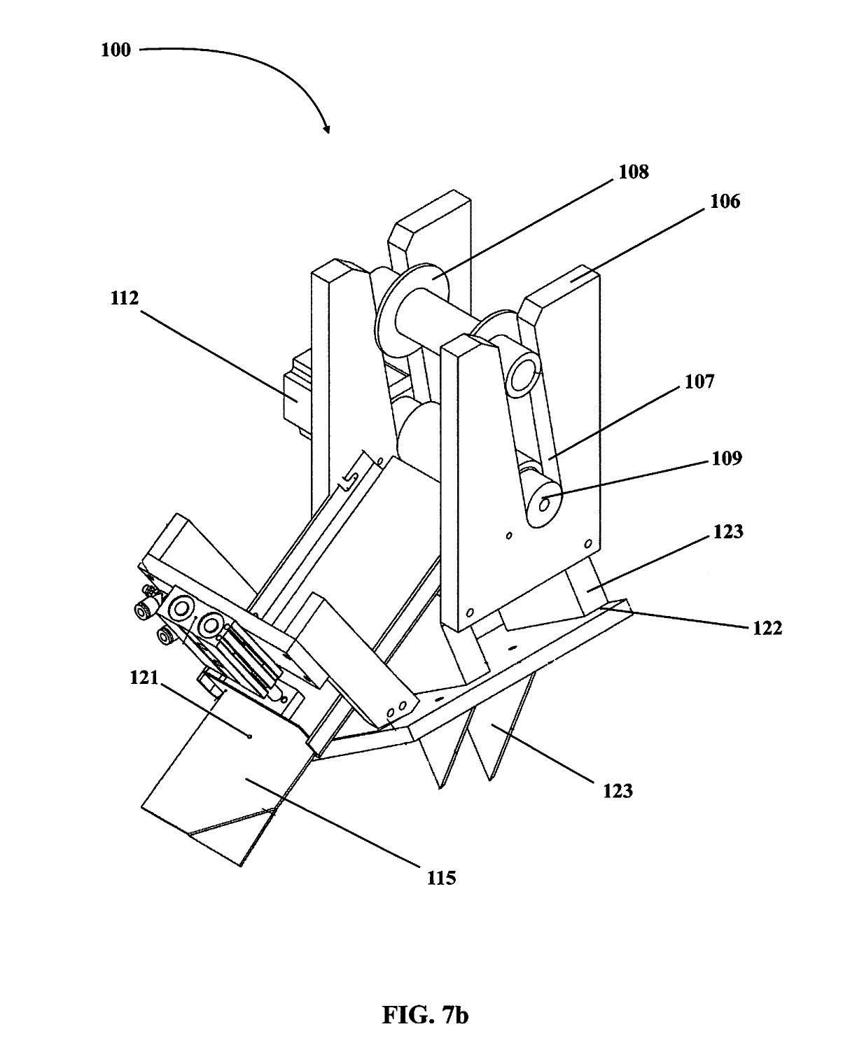

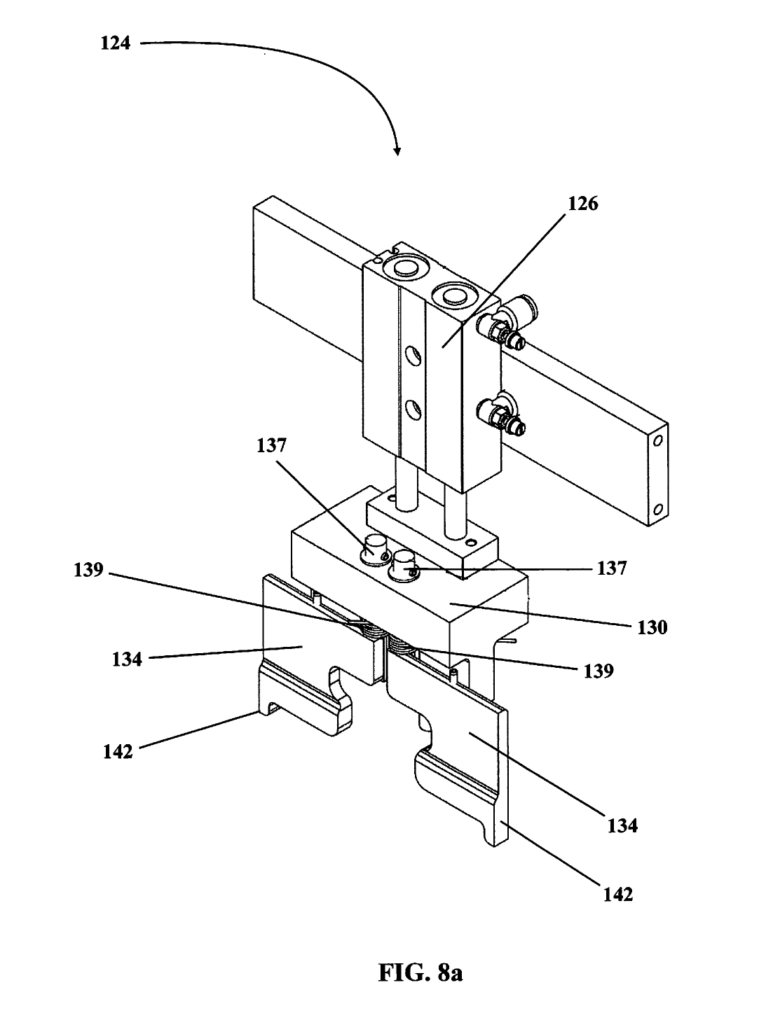

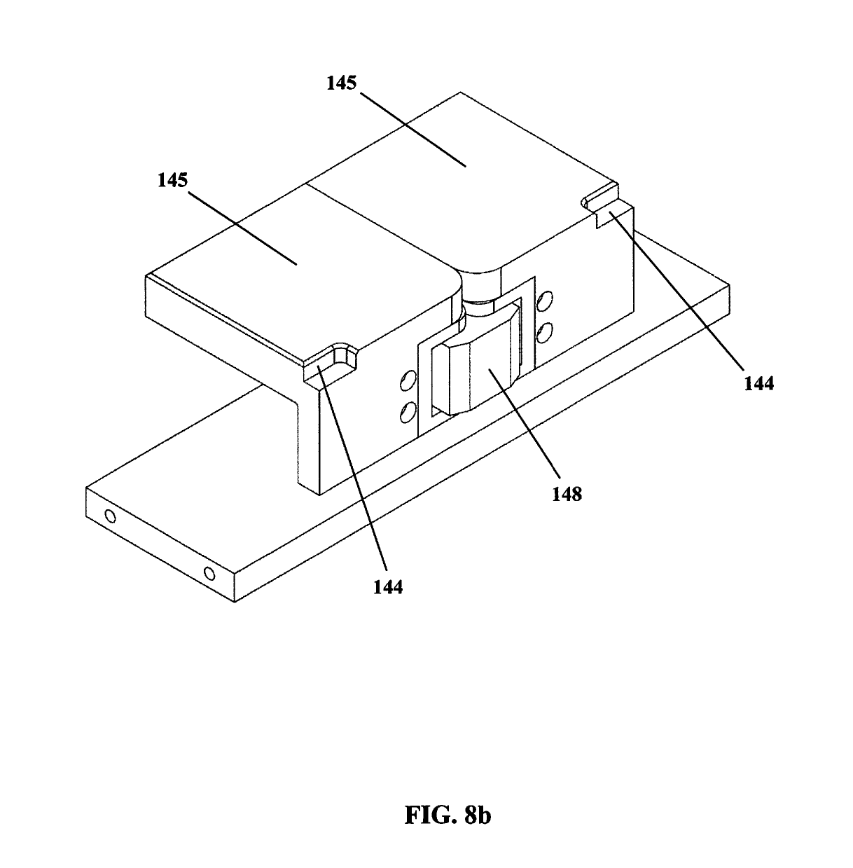

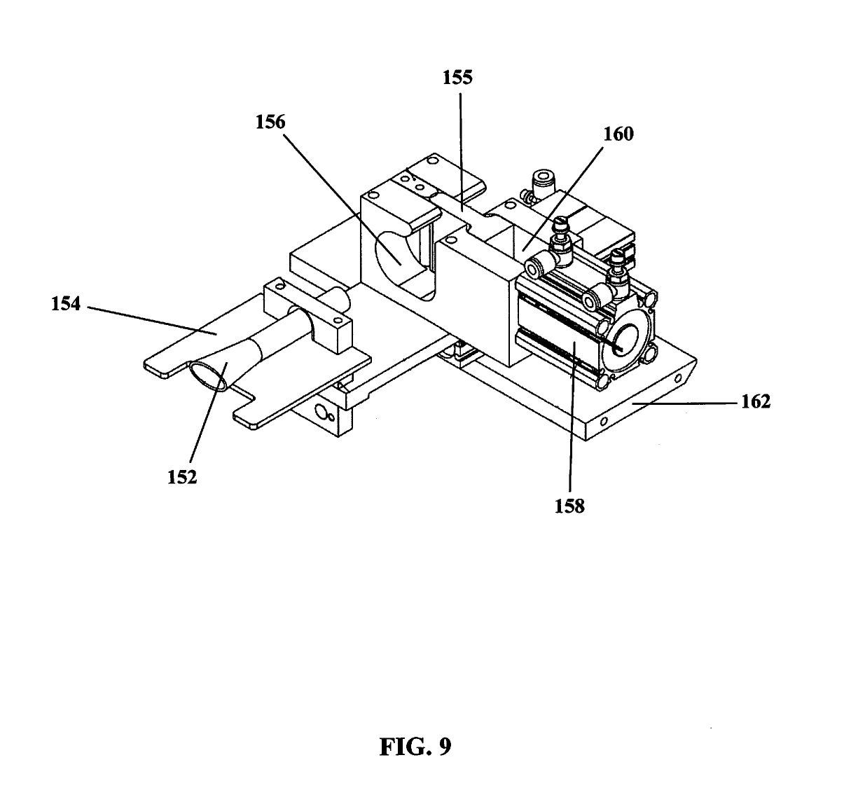

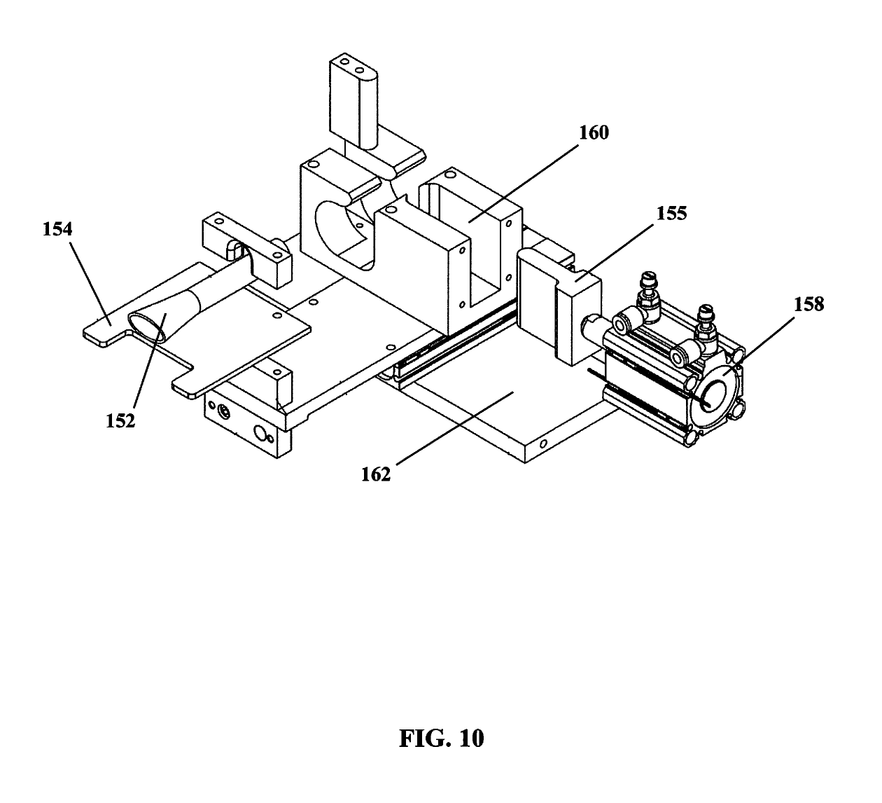

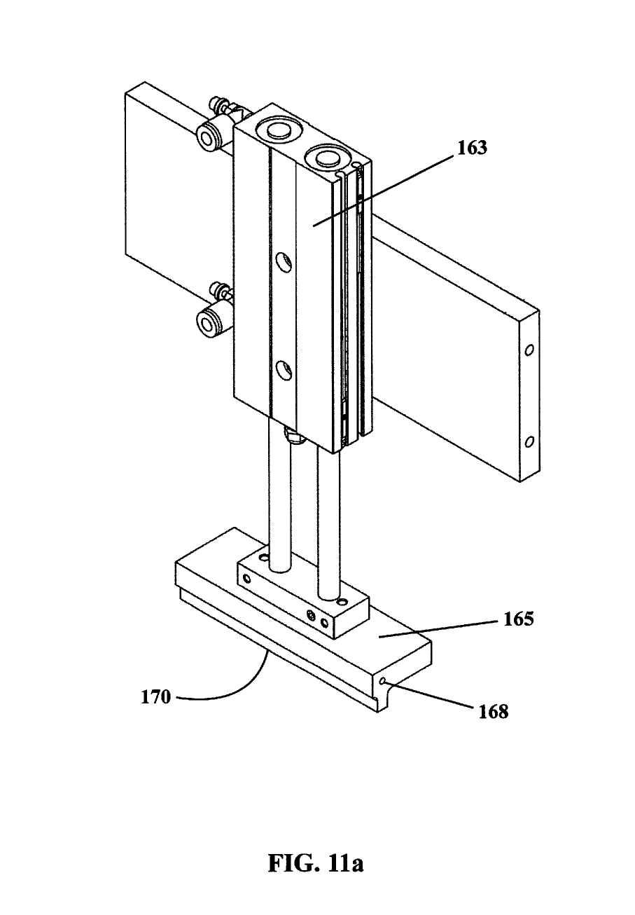

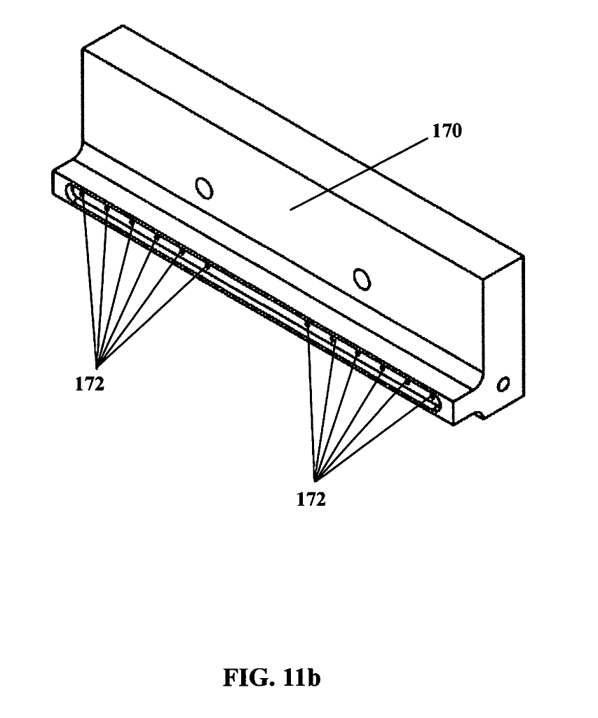

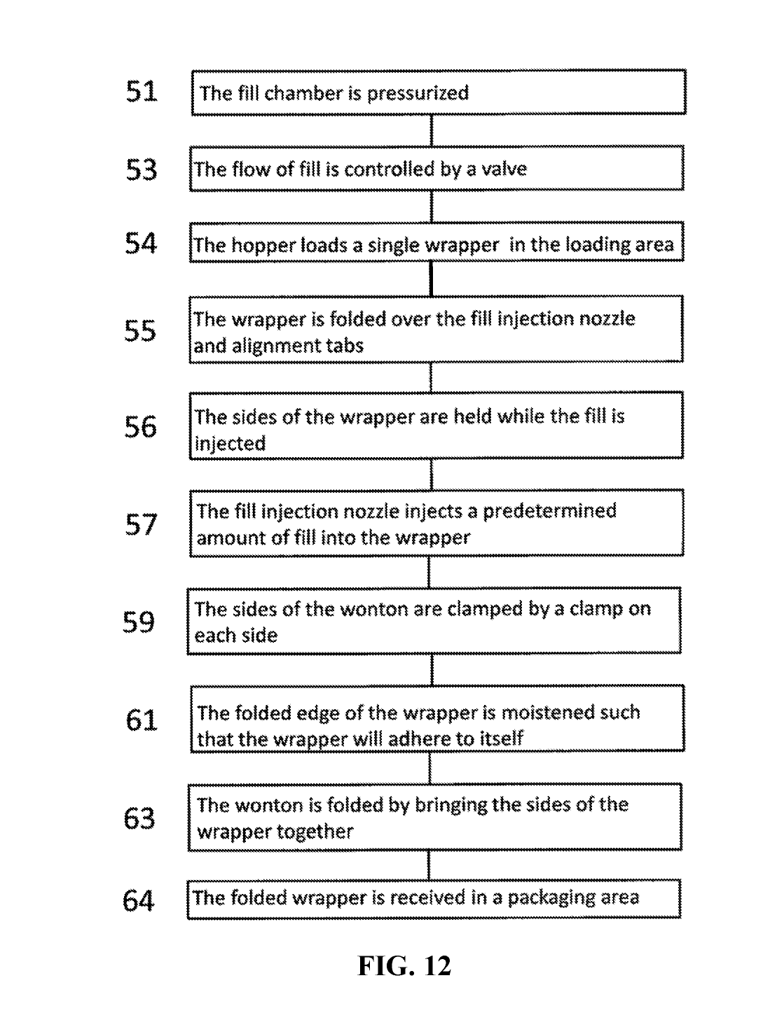

With reference to FIG. 6, a method of making a wonton is further disclosed. In step 51 a fill chamber in communication with a fill injection nozzle is pressurized, such that fill is forced to the fill injection nozzle by the pressure. In step 53, the flow of fill through the fill injection nozzle is controlled by a valve. The valve opening times may be controlled by a microprocessor or manual control taking into account the consistency of the fill such that the duration of the valve opening dispenses the correct amount of fill within the wonton wrapper. In step 55 the wonton wrapper is folded over the fill injection nozzle. In a preferred embodiment, the nozzle pushes the wonton through the loading plate, such that the wrapper is folded corner to opposite corner over the nozzle. In step 57 the fill injection nozzle injects a predetermined amount of fill into the wonton wrapper, after which the nozzle is removed from the wrapper. In step 59 the sides of the wonton wrapper are clamped using two clamps, one for each side. In one embodiment a single extended clamp may be used to clamp both sides. In step 61 the folded edge of the wonton wrapper is moistened such that the wonton wrapper will adhere to itself, and in step 63 the wonton is folded by bringing the sides of the wonton wrapper together.

In one embodiment, the wonton is folded when the clamps rotate towards each other. A further step 54 may be added wherein a hopper loads a single wonton wrapper into a loading area, separating the single wonton wrapper from a plurality of wrappers. A further step 56 of holding the sides of the wonton while the fill is injected to contain the fill may be used to contain the injected fill. A further step 64 of receiving the folded wonton in a packaging area may be beneficial for packaging the completed wonton. In an embodiment the wonton wrapper is folded by pushing the wonton wrapper through a loading plate, and the wonton wrapper may be folded from corner to opposite corner.

I claim:

1. A dumpling maker comprising:
a. a fill chamber capable of being pressurized;
b. a fill injector unit in communication with the fill chamber, the fill injector comprising:
i. a valve for controlling the flow of the fill; and
ii. a fill injector nozzle in communication with the valve for injecting fill within a dumpling wrapper; and
c. a dumpling folder unit comprising
i. a loading plate for loading dumpling wrappers;
ii. a split plate comprising first and second sides, each side rotatable independently, wherein the plate is for holding a folded dumpling wrapper having first and second sides;
iii. a first side wing clamp above the first side of the split plate, wherein the first side wing clamp and first side of the split plate move together to clamp the first side of the dumpling wrapper;
iv. a second side wing clamp above the second side of the split plate, wherein the second side wing clamp and second side of the split plate move together to clamp the second side of the dumpling wrapper; and
v. a moistener for moistening the folded edge of the dumpling wrapper,
wherein the fill injector unit is configured to receive fill from the fill chamber, the nozzle is configured to push the dumpling wrapper through the loading plate to fold the wrapper over the nozzle, the nozzle is configured to inject fill into the dumpling wrapper, and wherein the first side wing clamp and first side of the split plate are configured to meet the second side wing clamp and the second side of the split plate to join the first and second sides of the dumpling wrapper.

2. The dumpling maker of claim 1, further comprising a pressurization means for pressurizing the fill chamber.

3. The dumpling maker of claim 1, further comprising a fill tube for transmitting fill in communication with the fill chamber and the fill injector unit.

4. The dumpling maker of claim 1, further comprising one or more alignment tabs adjacent to the nozzle for folding the dumpling wrapper.

5. The dumpling maker of claim 1, further comprising a wonton cutter configured to cut a wrapper from a roll of wrapper, comprising:
a. a spool containing the roll of wrapper;
b. a motor shaft in frictional engagement with the roll configured to advance wrapper from the roll;
c. a sheet guide along which the wrapper advances; and
d. a cutter positioned along the sheet guide, to cut the wrapper.

6. The dumpling maker of claim 1, wherein the first side wing clamp and first side of the split plate rotate towards the second side wing clamp and the second side of the split plate to fold the dumpling, wherein the first side wing clamp and first side of the split plate are engaged with each other and the second side wing clamp and second side of the split plate are engaged with each other.

7. The dumpling maker of claim 1, further comprising a hopper for loading a plurality of dumpling wrappers, wherein dumpling wrappers are positioned one at a time on the loading plate.

8. The dumpling maker of claim 1, wherein the valve opening duration is adjusted depending on the consistency of the fill.

9. The dumpling maker of claim 5, wherein an eye is positioned along the sheet guide to determine a position of the wrapper for the cutter.

10. The dumpling maker of claim 1, wherein the dumpling folder unit is removable for cleaning.

11. The dumpling maker of claim 1, wherein the fill passes through a rubber hose, and the valve comprises a compressor that compresses the rubber hose to push fill out of the nozzle.

12. The dumpling maker of claim 1, wherein the valve is an air pinch valve.

13. The dumpling maker of claim 1, wherein the moistener is fed by a line containing liquid and the moistener comprises a manifold to distribute the liquid across the moistener.

14. A method of using a dumpling maker to make a dumpling, comprising the steps of:
a. pressurizing a fill chamber in communication with a fill injection nozzle;
b. controlling a flow of fill through a fill injection nozzle;
c. folding a dumpling wrapper over the fill injection nozzle;
d. the fill injection nozzle injecting fill into the dumpling wrapper;
e. clamping the sides of the dumpling wrapper using clamps;
f. moistening the folded edge of the dumpling wrapper; and
g. folding the dumpling by bringing the sides of the dumpling wrapper together.

15. The method of claim 14, wherein the dumpling is folded when the clamps rotate towards each other.

16. The method of claim 14, further comprising the step of holding the sides of the dumpling while the fill is injected to contain the fill.

17. The method of claim 14, further comprising the step of receiving the folded dumpling in a packaging area.

18. The method of claim 14, wherein the dumpling wrapper is folded by pushing the dumpling wrapper through a loading plate.

19. The method of claim 18, wherein the dumpling wrapper is folded from corner to opposite corner.

20. A dumpling maker comprising:
a. a fill injector unit in communication with a fill chamber, the fill injector comprising:
i. a compressor for controlling the flow of the fill; and
ii. a fill injector nozzle in communication with the compressor for injecting fill within a dumpling wrapper; and
b. a dumpling folder unit comprising:
i. a loading plate for loading dumpling wrappers;
ii. a split plate comprising first and second sides, each side rotatable independently, wherein the plate is for holding a folded dumpling wrapper having first and second sides;
iii. a first side wing clamp above the first side of the split plate, wherein the first side wing clamp and first side of the split plate engage with each other and move together to clamp the first side of the dumpling wrapper;
iv. a second side wing clamp above the second side of the split plate, wherein the second side wing clamp and second side of the split plate engage with each other and move together to clamp the second side of the dumpling wrapper; and
v. a moistener for moistening the folded edge of the dumpling wrapper,
wherein the fill injector unit is configured to receive fill from the fill chamber, and wherein the nozzle is configured to push the dumpling wrapper through the loading plate to fold the wrapper over the nozzle, and wherein the nozzle is configured to inject fill into the dumpling wrapper, and wherein the first side wing clamp and first side of the split plate are configured to meet the second side wing clamp and the second side of the split plate to join the first and second sides of the dumpling wrapper.
